(19) United States
(12) Patent Application Publication
(10) Pub. No.: US 2010/0081056 A1
(43) Pub. Date: Apr. 1, 2010

(54) NON-AQUEOUS ELECTROLYTE SECONDARY BATTERY, POSITIVE ELECTRODE ACTIVE MATERIAL USED FOR THE BATTERY, AND MANUFACTURING METHOD OF THE POSITIVE ELECTRODE ACTIVE MATERIAL

(75) Inventors: Motoharu Saito, Kobe-shi (JP); Masahisa Fujimoto, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/570,987

(22) Filed: Sep. 30, 2009

(30) Foreign Application Priority Data
Sep. 30, 2008 (JP) 2008-254709
Jul. 13, 2009 (JP) 2009-164585

(51) Int. Cl. H01M 4/50; H01M 10/05; H01B 1/08

(52) U.S. Cl. 429/224; 252/518.1

(57) ABSTRACT

A positive electrode active material includes a manganese oxide containing lithium and at least one substance selected from the group consisting of sodium, potassium, and rubidium. The manganese oxide has a strongest peak in the range of 2θ=42.0° to 46.0° and a second strongest peak in the range of 2θ=64.0° to 66.0°, as determined by X-ray powder diffraction analysis (Cukα) of the manganese oxide.

### BACKGROUND OF THE INVENTION

1. Field of the Invention

The present invention relates to non-aqueous electrolyte secondary batteries such as lithium-ion batteries and polymer batteries, positive electrode active materials used for the batteries, and manufacturing methods of the positive electrode active materials.

2. Description of Related Art

Mobile information terminal devices such as mobile telephones, notebook computers, and PDAs have become smaller and lighter at a rapid pace in recent years. This has led to a demand for higher capacity batteries as the drive power source for the mobile information terminal devices. With their high energy density and high capacity, non-aqueous electrolyte secondary batteries, which perform charge and discharge by transferring lithium ions between the positive and negative electrodes, have been widely used as a driving power source for the mobile information terminal devices.

The mobile information terminal devices tend to require greater power consumption as the number of functions of the devices, such as moving picture playing functions and gaming functions, increases. It is therefore strongly desired that the non-aqueous electrolyte secondary batteries that are the drive power source for the devices have further higher capacities and higher performance in order to achieve longer battery life and improved output power. In addition, applications of the non-aqueous electrolyte secondary batteries are expected to expand from just the above-described applications but to power tools, power assisted bicycles, and moreover HEVs. In order to meet such expectations, it is strongly desired that the capacity and the performance of the battery be improved further.

In order to increase the capacity of the non-aqueous electrolyte secondary battery, it is necessary to increase the capacity of the positive electrode. It has been proposed to use a lithium-containing layered compound, such as LiCoO₂, LiNiO₂, and LiNi_{1/3}CO_{1/3}Mn_{1/3}O₂, as the positive electrode active material for that purpose. However, cobalt and nickel used in the lithium-containing layered compound are expensive rare metals, and moreover, the supply is unstable. For this reason, it is desirable that they should be replaced with a substance that is low in cost and stable in supply.

In view of such circumstances, it has been proposed to a manganese oxide as the positive electrode active material. However, it is not sufficient to use simply any manganese oxide as the positive electrode active material. Even a manganese oxide that can reversibly intercalate and deintercalate lithium in the range of from 2.5 V to 5.0 V (vs. Li/Li⁺) has only a capacity density of 200 mAh/g or less, so it is difficult to regard it as a positive electrode material for increasing the capacity of the lithium-ion battery.

In view of the problems, the following proposals have been made.

(1) A proposal to use λ-MnO₂(LiMn₂O₄) as the positive electrode active material to increase the capacity (see Non-patent Document 1 below).

(2) A proposal to synthesize a lithium oxide by ion-exchanging a sodium oxide with a fused salt (see Patent Document 1 below).

[Patent Document 1] Japanese Published Unexamined Patent Application No. 2005-259362

[Non-patent document 1] Journal of the Electrochemical Society, Vol. 137(3), pp. 769-775 (1990)

### SUMMARY OF THE INVENTION

However, the above-mentioned proposals of conventional techniques have the following problems.

Problems with Proposal (1):

The battery using LiMn₂O₄ belonging to the space group Fd-3m as the positive electrode material shows a capacity density of about 120 mAh/g when charged and discharged in the range of from 2.8 V to 5.0 V, and about 210 mAh/g when charged and discharged in the range of from 2.0 V to 5.0 V. The capacity density varies greatly by setting the end-of-discharge potential to 2.0 V or to 2.8 V because this positive electrode material has two discharge plateaus at about 4.0 V and at about 2.5 V.

Consequently, when the battery is charged and discharged in the range of 2.0 V to 5.0 V, it is difficult to identify the remaining battery charge from the voltage although a certain degree of capacity density can be obtained, because it shows two discharge plateaus in the discharge characteristics. On the other hand, when the battery is charged and discharged in the range of 2.8 V to 5.0 V, the problem is that the capacity density becomes low although it is easy to identify the remaining battery charge from the voltage because it shows one discharge plateau.

Problems with Proposal (2):

The technique is not a common technique used for synthesis of a novel material with a different structure and composition ratio because a fused salt is used for ion-exchange of sodium and lithium. Accordingly, when sodium permanganate (NaMnO₄) undergoes ion-exchange, it is generally expected that LiMnO₄ is produced. In that case, the theoretical capacity is only 212 mAh/g, which means that the capacity is not sufficiently high.

Accordingly, it is an object of the present invention to provide a non-aqueous electrolyte secondary battery that shows a high capacity density, does not result in two discharge plateaus in the discharge characteristics, and is capable of identifying the remaining battery charge from the voltage. It is also an object of the invention to provide a positive electrode active material used for the battery and a method of manufacturing the positive electrode active material.

In order to accomplish the foregoing and other objects, the present invention provides a positive electrode active material comprising a manganese oxide containing lithium and at least one substance selected from the group consisting of sodium, potassium, and rubidium, the manganese oxide having a strongest peak in the range of 2θ=42.0° to 46.0° and a second strongest peak in the range of 2θ=64.0° to 66.0°, as determined by X-ray powder diffraction analysis (Cukα) of the manganese oxide.

The just-described positive electrode active material does not degrade the discharge capacity density, and prevents the battery from capacity loss. Moreover, unlike the foregoing LiMn₂O₄, it does not show two plateaus, and the discharge curve is gentle. Therefore, it is possible to detect the remaining capacity by measuring the voltage. In addition, the positive electrode active material is an oxide made of lithium, manganese, and sodium or the like, and it does not use a rare metal. Therefore, the positive electrode active material and the non-aqueous electrolyte secondary battery using the positive electrode active material can be manufactured at low cost.

It is desirable that the manganese oxide be represented by the chemical formula LiₐM_{b}MnOₓ (wherein M is at least one substance selected from the group consisting of Na, K, and Rb; 1.08<a<1.90; 0<b<0.018; and 0<x≦4). It is more desirable that 1.30<a<1.80 and 0.005<b<0.015 in the foregoing formula.

In addition, a manganese oxide represented by the chemical formula LiₐM_{b}MnOₓ in which a portion of Mn is substituted is also usable as the positive electrode active material. (Specifically, the manganese oxide is represented by the chemical formula LiₐM_{b}Mn_{1-y}Z_{y}Oₓ, where the substitute metal Z is at least one element selected from the group consisting of Li, Mg, Ni, Co, Al, Zr, Fe, Ti, Cr, Mo, and W. The kind of the element M, and the values a, b, and x are the same as in the foregoing.)

It is desirable that the manganese oxide have a wide peak in the range of 2θ=15.0° to 25.0°, the wide peak being weaker than those of the strongest peak and the second strongest peak, as determined by X-ray powder diffraction analysis (Cukα) of the manganese oxide.

The positive electrode active material may be manufactured by heating a mixture of permanganate and a fused salt bed to a higher temperature than the melting temperature of the fused salt bed.

It is desirable that the permanganate be at least one substance selected from the group consisting of sodium permanganate, potassium permanganate, and rubidium permanganate. Sodium permanganate is particularly desirable.

The reason why sodium permanganate is particularly preferable is that when using sodium permanganate, an improvement in the discharge capacity density becomes possible in addition to the detection of the remaining battery charge.

It is desirable that the fused salt bed be a mixture of lithium nitrate and at least one substance selected from the group consisting of nitrate, hydroxide, sulfate, iodide, bromide, fluoride, carbonate, perchlorate, tetrafluorophosphate, and oxide of sodium, potassium, lithium, or ammonium. A mixture of lithium hydroxide and lithium nitrate is particularly desirable.

The invention also provides a non-aqueous electrolyte secondary battery comprising a positive electrode, a negative electrode, and a non-aqueous electrolyte, in which the positive electrode uses a positive electrode active material according to any one of the foregoing active materials.

(1) It is desirable that the negative electrode active material used for the negative electrode be at least one substance selected from the group consisting of metallic lithium, a lithium-containing alloy, silicon, carbon, tin, germanium, aluminum, lead, indium, gallium, a carbon material in which lithium is absorbed in advance, and a silicon material in which lithium is absorbed in advance.

(2) The positive electrode functions even without adding a conductive agent when the active material has a high electrical conductivity. However, when the positive electrode contains an active material with a low electrical conductivity, it is desirable to use a conductive agent. Any material that shows electrical conductivity may be used as the conductive agent. It is possible to use at least one substance among an oxide, a carbide, and a nitride of a material that shows high conductivity, and a carbon materials. Examples of the oxide include tin oxide and indium oxide. Examples of the carbide include tungsten carbide and zirconium carbide. Examples of the nitride include titanium nitride and tantalum nitride. In the case of adding a conductive agent, the conductivity in the positive electrode cannot be improved sufficiently if the amount of the conductive agent added is too small. On the other hand, if the amount of the conductive agent added is too large, the relative proportion of the active material in the positive electrode becomes too low, so the energy density becomes low. For this reason, it is desirable that the amount of the conductive agent be restricted to 30 mass % or less, preferably 20 mass % or less, and more preferably 10 mass % or less, with respect to the total amount of the positive electrode active material layer.

(3) Examples of the binder used for the positive electrode include polytetrafluoroethylene, polyvinylidene fluoride, polyethylene oxide, polyvinyl acetate, polymethacrylate, polyacrylate, polyacrylonitrile, polyvinyl alcohol, styrene-butadiene rubber, carboxymethylcellulose, and combinations thereof. When the amount of the binder agent added to the positive electrode is too large, the energy density of the positive electrode lowers because the relative proportion of the active material contained in the positive electrode is small. For this reason, it is desirable that the amount of the binder be restricted to 30 mass % or less, preferably 20 mass % or less, and more preferably 10 mass % or less, with respect to the total amount of the positive electrode active material layer.

(4) Examples of the solvent of the non-aqueous electrolyte used in the present invention include cyclic carbonic esters, chain carbonic esters, esters, cyclic ethers, chain ethers, nitriles, and amides.

Examples of the cyclic carbonic esters include ethylene carbonate, propylene carbonate, and butylenes carbonate. It is also possible to use a cyclic carbonic ester in which part or all of the hydrogen groups of the just-mentioned cyclic carbonic esters is/are fluorinated. Examples of such a substance include trifluoropropylene carbonate and fluoroethyl carbonate.

Examples of the chain carbonic esters include dimethyl carbonate, ethyl methyl carbonate, diethyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is fluorinated.

Examples of the esters include methyl acetate, ethyl acetate, propyl acetate, methyl propionate, ethyl propionate, and γ-butyrolactone. Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile. Examples of the amides include dimethylformamide. These substances may be used either alone or in combination.

(5) The lithium salt to be added to the non-aqueous solvent may be any lithium salt that is commonly used in conventional non-aqueous electrolyte secondary batteries. It is possible to use, for example, at least one substance selected from LiBF₄, LiPF₆, LiCF₃SO₃, LiC₄F₉SO₃, LiN(CF₃SO₂)₂, LiN(C₂F₅SO₂)₂, LiAsF₆, and lithium difluoro(oxalate)borate.

According to the present invention, the following advantageous effects are obtained. The capacity density is prevented from becoming poor. Moreover, the positive electrode active material does not result in two discharge plateaus in the discharge characteristics, so it is easy to identify the remaining battery charge from the voltage.

### BRIEF DESCRIPTION OF THE DRAWINGS

FIG. 1 is a view illustrating a test cell used in the present invention;

FIG. 2 is a graph illustrating the results of the XRD analysis for the positive electrode active materials used in the present invention cells A1 and A2 and comparative cells Z1, Z3, and Z4;

FIG. 3 is a graph illustrating the results of the XRD analysis for NaMnO₄.H₂O used as a starting material;

FIG. 4 is a graph showing the relationship between the charge-discharge capacity density and the potential of the present invention cell A1;

FIG. 5 is a graph showing the relationship between the charge-discharge capacity density and the potential of a comparative cell Z1;

FIG. 6 is a graph showing the relationship between the charge-discharge capacity density and the potential of a comparative cell Z2; and

FIG. 7 is a graph showing the relationship between the charge-discharge capacity density and the potential of the present invention cell A2.

### DETAILED DESCRIPTION OF THE INVENTION

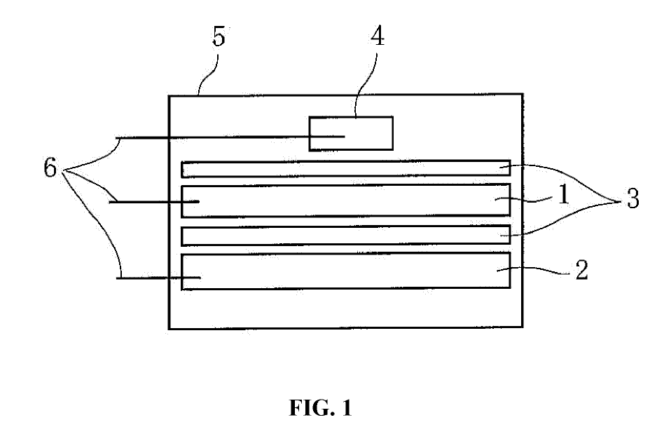

Hereinbelow, preferred embodiments of the positive electrode active material according to the invention and the non-aqueous electrolyte secondary battery using the positive electrode active material will be described with reference to FIG. 1. It should be construed, however, the invention is not limited to the following embodiments and examples but various changes and modifications are possible without departing from the scope of the invention.

### Preparation of Working Electrode

First, 5 g (about 0.03 mole) of sodium permanganate monohydrate (NaMnO₄.H₂O) was prepared as a starting material, and 5 times equivalent amount of a fused salt bed is added thereto. The fused salt bed was prepared by mixing lithium nitrate and lithium hydroxide at a mole ratio of 60.8/39.2 (melting point: 186° C.). The mass of the fused salt bed was 9.1 g (about 0.16 mole). Next, the foregoing mixture was sintered at 200° C. for 10 hours using an electric furnace, and thereafter, unreacted fused salt bed and permanganate were washed with water, to obtain a precipitate. Lastly, the precipitate was dried at 100° C. for 10 hours to obtain a positive electrode active material.

Thereafter, 80 mass % of the just-described positive electrode active material, 10 mass % of acetylene black as a conductive agent, and 10 mass % of polyvinylidene fluoride as a binder agent were mixed together, and N-methyl-2-pyrrolidone was added to the mixture, to obtain a slurry. Lastly, this slurry was applied onto a current collector, then vacuum dried at 110° C. and shaped, to obtain a working electrode.

### Preparation of Counter Electrode and Reference Electrode

Metallic lithium plate was cut into a predetermined size, and a tab was attached thereto, to thereby obtain a counter electrode and a reference electrode.

### Preparation of Non-Aqueous Electrolyte

Lithium hexafluorophosphate (LiPF₆) was dissolved at a concentration of 1 mole/L in a mixed electrolyte of 3:7 volume ratio of ethylene carbonate (EC) and diethyl carbonate (DEC), whereby a non-aqueous electrolyte solution was prepared.

### Preparation of Test Cell

Under an inert atmosphere, a counter electrode 2, a separator 3, a working electrode 1, a separator 3, and a reference electrode 4 were disposed in a test cell container 5 made of a laminate film. Then, the above-described non-aqueous electrolyte was filled in the test cell container 5. Thus, a test cell shown in FIG. 1 was prepared. Leads 6 were disposed so that a portion of each of the leads 6 protrudes from the test cell container 5.

### EXAMPLES

### Example 1

A cell prepared in the manner described in the foregoing preferred embodiment was used for Example 1.

The cell prepared in this manner is hereinafter referred to as a present invention cell A1.

### Example 2

A cell was prepared in the same manner as described in Example 1 above, except that, when preparing the positive electrode active material, 5 g (about 0.03 mole) of potassium permanganate (KMnO₄) was used as the starting material, a mixture of lithium nitrate and lithium hydroxide mixed at a mole ratio of 61/39 was used as the fused salt bed (melting point: 186° C.), and the mass of the fused salt bed was about 9.2 g (about 0.16 mole).

The cell prepared in this manner is hereinafter referred to as a present invention cell A2.

### Comparative Example 1

A cell was prepared in the same manner as described in Example 1, except that 10 g (about 0.16 mole) of a mixture of lithium nitrate and lithium chloride (melting point: 244° C.) mixed at a mole ratio of 88.0/12.0 was used as the fused salt bed in preparing the positive electrode active material, and that the sintering by an electric furnace was carried out at 280° C. for hours.

The cell fabricated in this manner is hereinafter referred to as a comparative cell Z1.

### Comparative Example 2

A cell was prepared in the same manner as described in Example A1 above, except that a spinel LiMn₂O₄, commonly used as the positive electrode for the lithium secondary battery, was used the positive electrode active material.

The cell fabricated in this manner is hereinafter referred to as a comparative cell Z2.

### Comparative Example 3

A cell was prepared in the same manner as in described in Example 1, except that the positive electrode active material was prepared in the following manner.

5 g (about 0.03 mole) of sodium permanganate (NaMnO₄.H₂O) was used as the starting material, and this was sintered at 200° C. for 10 hours. Thereafter, unreacted fused salt bed and permanganate were washed with water, to obtain a precipitate. Lastly, the precipitate was dried at 100° C. for 10 hours to obtain a positive electrode active material.

The cell fabricated in this manner is hereinafter referred to as a comparative cell Z3.

### Comparative Example 4

A cell was prepared in the same manner as in described in Example 1, except that the positive electrode active material was prepared in the following manner.

5 g (about 0.03 mole) of potassium permanganate (KMnO₄) was used as the starting material, and this was sintered at 200° C. for 10 hours. Thereafter, unreacted fused salt bed and permanganate were washed with water, to obtain a precipitate. Lastly, the precipitate was dried at 100° C. for 10 hours to obtain a positive electrode active material.

The cell fabricated in this manner is hereinafter referred to as a comparative cell Z4.

### Experiment 1

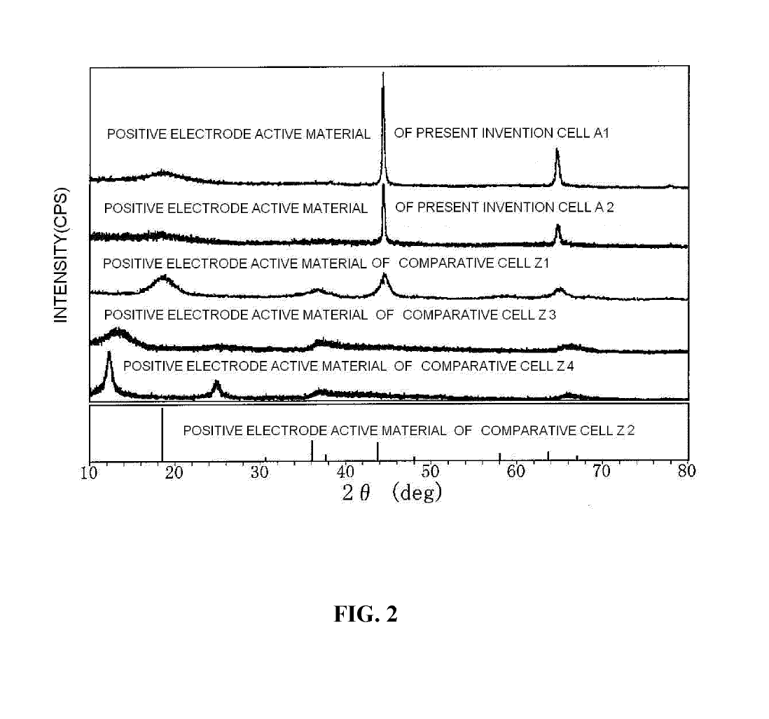

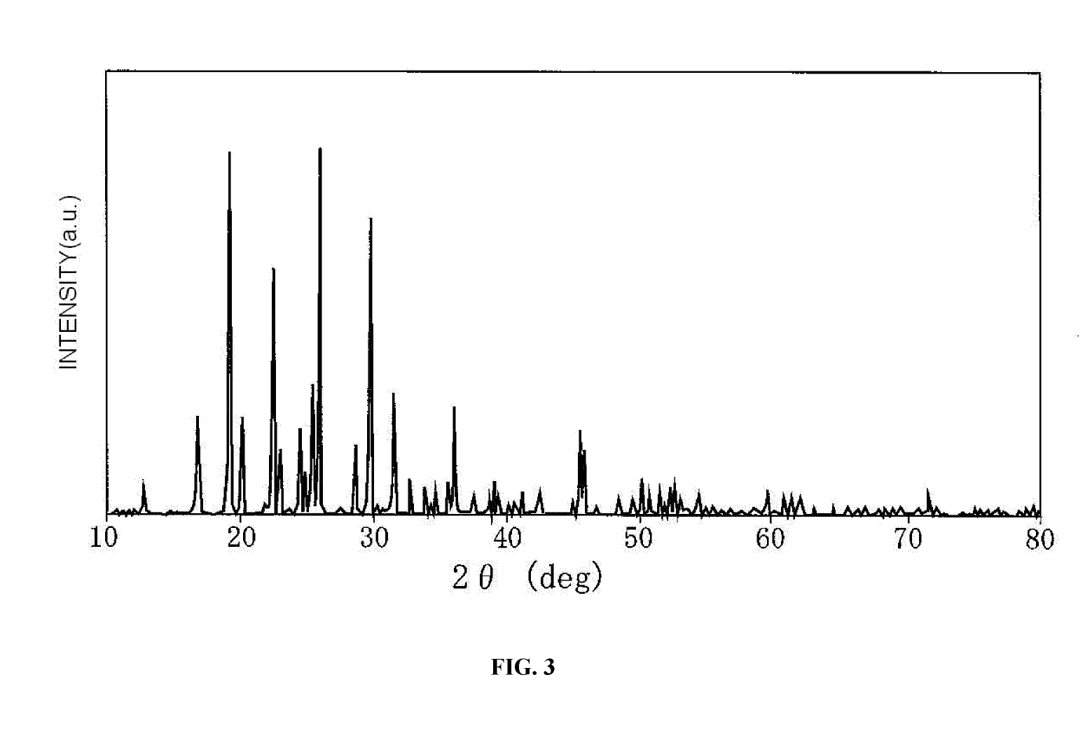

The positive electrode active materials used for the present invention cells A1 and A2 and the comparative cells Z1, Z3, and Z4 were subjected to an XRD analysis (radiation source: Cukα). The results are shown in FIG. 2. (In FIG. 2, the X-ray profile of the positive electrode active material (Powder Diffraction File 35-0782; LiMn₂O₄) used for the comparative cell Z2 is also shown for reference.) In addition, NaMnO₄.H₂O, the starting material of the positive electrode active material used for the present invention cell A1, was also subjected to the XRD analysis (radiation source Cukα). The result is shown in FIG. 3.

As clearly seen from FIGS. 2 and 3, the positive electrode active materials of the present invention cell A1 and the comparative cell Z1 show different peak profiles from that of the starting material NaMnO₄H₂O, so it is understood that they have different crystal structures. In addition, when the positive electrode active material of the present invention cell A1 and that of the comparative cell Z1 were compared, it is observed that the positive electrode active material of the comparative cell Z1 has a similar structure to the positive electrode active material of the present invention cell A1, except that the positive electrode active material of the comparative cell Z1 has a wide peak in the range 2θ=34.0° to 40.0°, that the peak intensity in 2θ=15.0° to 25.0° is the second strongest in the profile, and that the widths of the peaks are wider.

Judging from the peaks, the positive electrode active material of the present invention cell A1 is believed to have a face-centered cubic system, and the peaks in the vicinities of 38° to 39°, 44° to 45°, 64° to 66°, and 78° can be indexed as 111, 200, 220, and 311, respectively.

The positive electrode active material of the present invention cell A1 was compared with manganese oxides shown in the powder X-ray diffraction database [International Centre for Diffraction Data (ICDD)], but none of them matched the profile of the positive electrode active material of the present invention cell A1. The Powder Diffraction File (PDF) numbers of the substances compared are shown in Tables 1 and 2 below.

TABLE 1

| Chemical formula | PDF # |
|---|---|
| Li_{0.40}Mn_{0.60}O | 54-0262 |
| Li_{1.008}Mn_{2.017}O₄ | 54-0250 |
| Li_{1.024}Mn_{2.048}O₄ | 54-0254 |
| Li_{1.037}Mn_{2.073}O₄ | 54-0259 |
| Li_{1.054}Mn_{2.019}O₄ | 54-0251 |
| Li_{1.059}Mn_{2.118}O₄ | 54-0255 |
| Li_{1.05}Mn₂O₄ | 51-0537 |
| Li_{1.126}Mn_{2.252}O₄ | 54-0256 |
| Li_{1.147}Mn_{2.295}O₄ | 54-0260 |
| Li_{1.223}Mn_{2.447}O₄ | 54-0261 |
| Li_{1.27}Mn_{1.73}O₄ | 51-1582 |
| Li_{1.4}Mn_{1.7}O₄ | 53-0822 |
| Li_{1.4}Mn_{1.7}O₄ | 53-0821 |
| Li_{1.4}Mn_{1.7}O₄ | 53-0820 |
| Li_{1.6}Mn_{1.2}Cl₄ | 51-0305 |
| Li_{1.6}Mn_{1.6}O₄ | 52-1841 |
| Li₂Mn₂O₄ | 38-0299 |
| Li₄Mn₁₄O₂₇•ₓH₂O | 50-0009 |
| Li₄Mn₅O₁₂ | 46-0810 |
| Mn | 17-0910 |
| Mn | 21-0547 |
| Mn | 33-0887 |
| Mn | 32-0637 |
| Mn(OH)₂ | 18-0787 |
| Mn(OH)₄ | 15-0604 |
| Mn⁺²O | 07-0230 |
| Mn⁺³O(OH) | 12-0733 |
| Mn⁺³O(OH) | 18-0804 |
| Mn⁺³O(OH) | 24-0713 |
| Mn⁺³O(OH) | 41-1379 |
| Mn₁₅C₄ | 20-0706 |
| Mn₂₃C₆ | 28-0646 |
| Mn₂O₃ | 33-0900 |
| Mn₂O₃ | 41-1442 |
| Mn₂O₃ | 24-0508 |
| Mn₃O₄ | 13-0162 |
| Mn₃O₄ | 04-0732 |

TABLE 2

| Chemical formula | PDF # |
|---|---|
| Mn₃O₄ | 18-0803 |
| Mn₃O₄ | 24-0734 |
| Na_{0.55}Mn₂O₄•1.5H₂O | 43-1456 |
| Na₁₄Mn₂O₉ | 44-0855 |
| Na₂Mn₅O₁₀ | 27-0749 |
| Na₂Mn₈O₁₆ | 29-1244 |
| Na₃Li₅Mn₅O₉ | 39-0666 |
| Na₄Mn₁₄O₂₇•21H₂O | 32-1128 |
| Na₄Mn₁₄O₂₇•9H₂O | 23-1046 |
| Na₄Mn₉O₁₈ | 27-0750 |
| LiCl | 04-0664 |
| LiCl•H₂O | 22-1142 |
| LiNO₃ | 08-0466 |
| LiNO₃•3H₂O | 24-0645 |
| NaMnO₄•3H₂O | 01-0584 |
| LiOH | 32-0564 |
| LiOH•H₂O | 25-0486 |
| LiOH•H₂O | 24-0619 |
| LiMn₂O₄ | 54-0257 |
| LiMn₂O₄ | 54-0253 |
| LiMn₂O₄ | 54-0252 |
| LiMn₂O₄ | 53-1237 |
| LiMn₂O₄ | 53-1236 |
| LiMn₂O₄ | 53-0830 |
| LiMn₂O₄ | 35-0782 |
| LiMn₂O₄ | 54-0258 |
| Li₂Mn₂O₃ | 27-1252 |
| Na_{0.70}MnO₂ | 27-0752 |
| Na_{0.70}MnO_{2.05} | 27-0751 |
| MnO₂ | 44-0142 |
| MnO₂ | 12-0141 |
| MnO₂ | 44-0992 |
| MnO₂ | 50-0866 |
| MnO₂ | 44-0141 |
| MnO₂ | 43-1455 |
| MnO₂ | 53-0633 |
| MnO₂ | 42-1316 |

Moreover, As clearly seen from FIG. 2, the positive electrode active material of the present invention cell A2 shows substantially the same peaks as those of the positive electrode active material of the present invention cell A1, so it is believed that they have substantially the same crystal structure. On the other hand, it is observed that the positive electrode active materials of the comparative cells Z3 and Z4, which was prepared by using the same starting material, permanganate, as that of the present invention cells A1 and A2 but being heat-treated without adding a lithium salt, have different peak profiles from those of the positive electrode active materials of the present invention cells A1 and A2. This demonstrates that the positive electrode active materials of the present invention cells A1 and A2 are substances that can be synthesized when permanganate and a lithium salt react with each other, and they cannot be synthesized by merely heat-treating permanganate without adding a lithium salt, even with the same heat treatment conditions. Thus, it is understood that the positive electrode active materials of the present invention cells A1 and A2 are not mere decomposition products of permanganate.

### Experiment 2

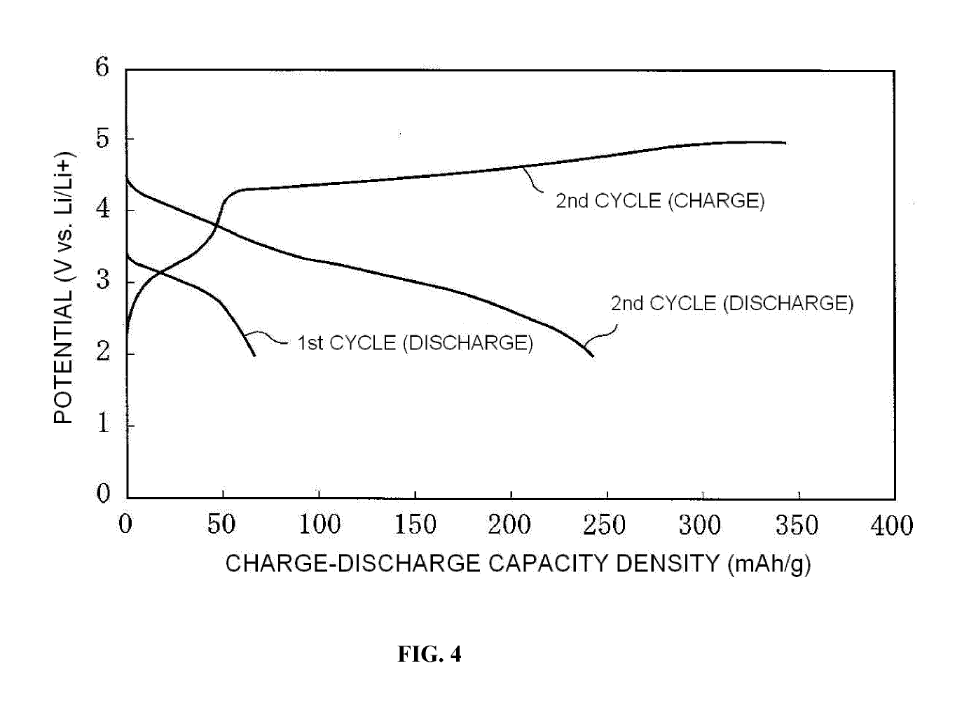

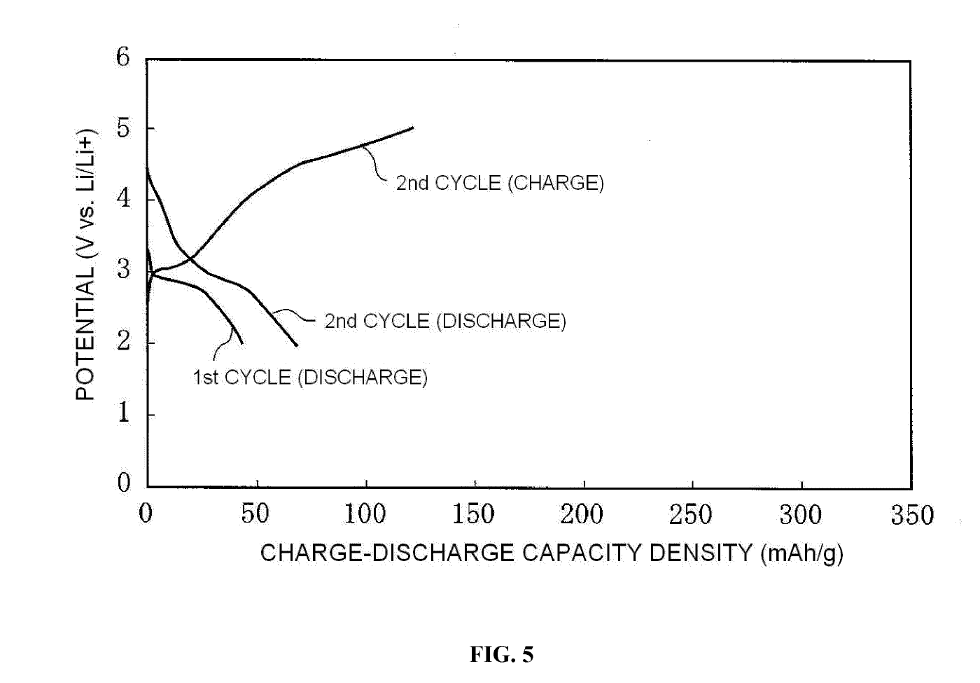

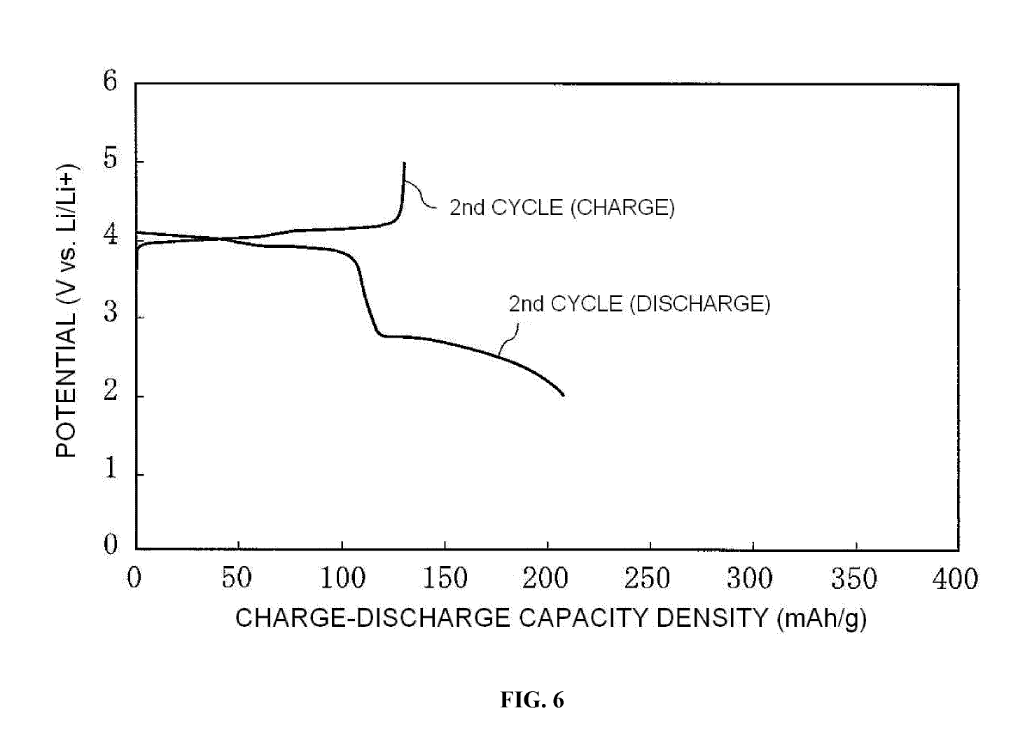

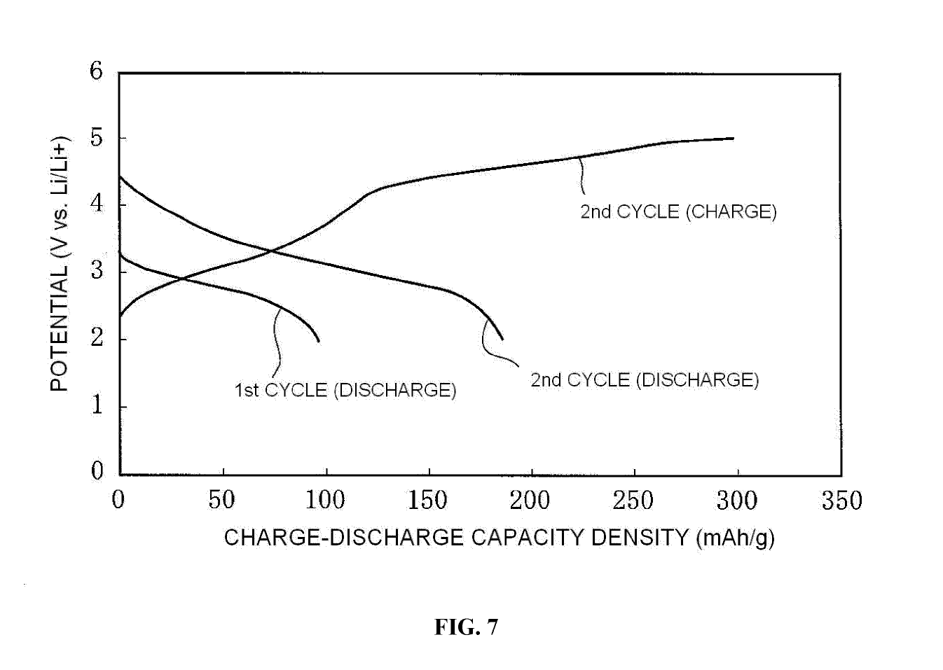

Each of the present invention cells A1 and A2 and the comparative cells Z1 and Z2 was charged and discharged under the following conditions to determine the charge-discharge capacity density of each of the cells. The results are shown in FIGS. 4 to 7. FIG. 4 is a graph showing the relationship between the charge-discharge capacity density and the potential of the present invention cell A1. FIG. 5 is a graph showing the relationship between the charge-discharge capacity density and the potential of the comparative cell Z1. FIG. 6 is a graph showing the relationship between the charge-discharge capacity density and the potential of the comparative cell Z2. FIG. 7 is a graph showing the relationship between the charge-discharge capacity density and the potential of the present invention cell A2.

### Charge-Discharge Conditions

Each of the cells was discharged for the first cycle at a constant current density of 0.09 mA/cm² or less to 2.0 V (vs. Li/Li⁺). Thereafter, each of the cells was charged for the second cycle at a constant current density of 0.09 mA/cm² or less to 5.0 V (vs. Li/Li⁺), and further discharged for the second cycle at a constant current density of 0.09 mA/cm² or less to 2.0 V (vs. Li/Li⁺).

When the cell is charged/discharged at a constant current density of 0.09 mA/cm² or less, the measurement of the discharge capacity density is not affected by the rate of the discharge current value. Therefore, it is possible to compare the discharge capacity density values of the cells as described below, under the assumption that the cells are charged and discharged under the same conditions.

As clearly seen from FIG. 4, the present invention cell A1 shows a discharge capacity density of 244 mAh/g to 2.0 V (vs. Li/Li⁺), a discharge capacity density of 213 mAh/g to 2.5 V (vs. Li/Li⁺), and a discharge capacity density of 183 mAh/g to 2.8 V (vs. Li/Li⁺). Thus, it is observed that the present invention cell A1 shows very high discharge capacity densities at all the potentials. Furthermore, the present invention cell A1 does not show two discharge plateaus but it has a gentle discharge curve. Therefore, it exhibits the advantage that the remaining battery charge can be detected easily, in addition to the advantage that the discharge capacity density is very high (i.e., the battery capacity can be increased).

On the other hand, as clearly seen from FIG. 5, it is observed that the comparative cell Z1 shows a discharge capacity density of only 69 mAh/g to 2.0 V (vs. Li/Li⁺), so it has a very low discharge capacity density.

As clearly seen from FIG. 6, the comparative cell Z2 shows a discharge capacity density of 208 mAh/g to 2.0 V (vs. Li/Li⁺), a discharge capacity density of 175 mAh/g to 2.5 V (vs. Li/Li⁺), and a discharge capacity density of 118 mAh/g to 2.8 V (vs. Li/Li⁺). Thus, it is observed that although the comparative cell Z2 shows higher discharge capacity densities than the comparative cell Z1, it shows lower discharge capacity densities than the present invention cell A1. Moreover, it is observed that the comparative cell Z2 results in two discharge plateaus in the discharge characteristics.

It should be noted that the present invention cell A1 a discharge capacity density of 66 mAh/g for the first cycle and a charge capacity density of 343 mAh/g for the second cycle. Thus, it is a feature of the positive electrode active material of the present invention cell A1 that it has a higher charge capacity density than the discharge capacity density at the initial stage charge-discharge cycles.

As clearly seen from FIG. 7, the present invention cell A2 shows a discharge capacity density of 185 mAh/g to 2.0 V (vs. Li/Li⁺), a discharge capacity density of 173 mAh/g to 2.5 V (vs. Li/Li⁺), and a discharge capacity density of 153 mAh/g to 2.8 V (vs. Li/Li⁺). Accordingly, although the present invention cell A2, made with potassium permanganate as the starting material, shows a sufficiently high discharge capacity density to 2.8 V (vs. Li/Li⁺) than the comparative cell Z2, the discharge capacities to 2.0 V and 2.5 V (vs. Li/Li⁺) are almost the same. However, the present invention cell A2 has an advantage that the remaining battery charge can be detected easily in comparison with the comparative cell Z2, because the present invention cell A2 does not have two discharge plateaus unlike the comparative cell Z2 and shows a gentle discharge curve.

Hence, from the viewpoint of detection of the remaining battery charge, it is possible to use potassium permanganate (the present invention cell A2), not just sodium permanganate (the present invention cell A1), as the starting material. However, it is preferable to use sodium permanganate as the starting material in order to obtain the advantage of an increase in the discharge capacity density, in addition to the detection of the remaining battery charge.

### Experiment 3

A composition analysis was conducted for the positive electrode active materials of the present invention cells A1 and A2 and those of the comparative cells Z1, Z3, and Z4. The results are shown in FIG. 3. The composition analysis was performed by flame photometry for Li (lithium), Na (sodium), and K (potassium), and by ICP (inductively coupled plasma) for Mn (manganese). In Table 3, the composition ratios of Li, Na, and K were calculated taking the composition of Mn as 1.00.

TABLE 3

| Type of positive electrode active material | Li | Na | K | Mn |
|---|---|---|---|---|
| Positive electrode active material of the | 1.71 | 0.010 | — | 1.00 |
| present invention cell A1 | | | | |
| Positive electrode active material of the | 1.34 | — | 0.007 | |
| present invention cell A2 | | | | |
| Positive electrode active material of the | 1.08 | 0.018 | — | |
| comparative cell Z1 | | | | |
| Positive electrode active material of the | <0.002 | 0.492 | — | |
| comparative cell Z3 | | | | |
| Positive electrode active material of the | <0.002 | — | 0.353 | |
| comparative cell Z14 | | | | |

The positive electrode active materials of the present invention cells A1 and A2 and those of the comparative cells Z1, Z3, and Z4 employ sodium permanganate or potassium permanganate as the starting material. However, Table 3 clearly shows that, in the positive electrode active materials of the present invention cells A1 and A2 and the comparative cell Z1, which are synthesized by ion-exchanging with a fused salt bed of lithium, the amount of Na or K contained in the starting material (the proportion taken the amount of Mn as 1.00) is about 0.01 at greatest, but the amount of Li is 1.00 or greater. So, it is observed that the primary compound is a lithium compound. On the other hand, the positive electrode active materials of the comparative cells Z3 and Z4, which were synthesized without using a lithium fused salt bed, contain a large amount of alkali metal compound as the starting material, but they contain very small amounts of Li. Therefore, it is understood that the primary compound is not a lithium compound.

It should be noted that, from the comparison between the positive electrode active material of the present invention cell A1 and that of comparative cell Z1, the composition ratio of lithium:sodium:manganese should be 1.08<a<1.90 and 0<b<0.018, more preferably 1.30<a<1.80 and 0.005<b<0.015, where Li:Mn:n=a:b:1. The lithium content (the value a) is restricted to greater than 1.08 and less than 1.90 when the amount of manganese is set to 1.00 for the following reason. When the lithium content exceeds 1.08, the structure becomes stable, but when the lithium content becomes 1.90 or greater, the structure becomes instable, making the synthesis of the positive electrode active material difficult. For this reason, it is believed that the synthesis of the positive electrode active material is easy when the lithium content is greater than 1.08 but less than 1.90 (especially when the lithium content is greater than 1.30 but less than 1.80). In the case of the positive electrode active material of the present invention cell A2 as well, it is desirable that the composition ratio of lithium and potassium and manganese be the same as described above, where Li:K:Mn=a:b:1.

The present invention is applicable to power sources for mobile information terminals such as mobile telephones, notebook computers, and PDAs. The invention is also expected to be applicable to power sources that require high power, such as HEVs and power tools.

What is claimed is:

1. A positive electrode active material comprising a manganese oxide containing lithium and at least one substance selected from the group consisting of sodium, potassium, and rubidium, the manganese oxide having a strongest peak in the range of 2θ=42.0° to 46.0° and a second strongest peak in the range of 2θ=64.0° to 66.0°, as determined by X-ray powder diffraction analysis (Cukα) of the manganese oxide.

2. The positive electrode active material according to claim 1, wherein the manganese oxide is represented by the chemical formula LiₐM_{b}MnOₓ, where: M is at least one substance selected from the group consisting of Na, K, and Rb; 1.08<a<1.90; 0<b<0.018; and 0<x≦4.

3. The positive electrode active material according to claim 1, wherein a and b in the manganese oxide are: 1.30<a<1.80 and 0.005<b<0.015.

4. The positive electrode active material according to claim 1, wherein the manganese oxide has a wide peak in the range of 2θ=15.0° to 25.0°, the wide peak being weaker than those of the strongest peak and the second strongest peak, as determined by X-ray powder diffraction analysis (Cukα) of the manganese oxide.

5. The positive electrode active material according to claim 2, wherein the manganese oxide has a wide peak in the range of 2θ=15.0° to 25.0°, the wide peak being weaker than those of the strongest peak and the second strongest peak, as determined by X-ray powder diffraction analysis (Cukα) of the manganese oxide.

6. The positive electrode active material according to claim 3, wherein the manganese oxide has a wide peak in the range of 2θ=15.0° to 25.0°, the wide peak being weaker than those of the strongest peak and the second strongest peak, as determined by X-ray powder diffraction analysis (Cukα) of the manganese oxide.

7. The positive electrode active material according to claim 1, wherein the manganese oxide has a peak or peaks in the range of 2θ=38.0° to 39.5° and/or in the range of 2θ=77.0° to 79.0°, determined by X-ray powder diffraction analysis (Cukα) of the manganese oxide.

8. The positive electrode active material according to claim 2, wherein the manganese oxide has a peak or peaks in the range of 2θ=38.0° to 39.5° and/or in the range of 2θ=77.0° to 79.0°, determined by X-ray powder diffraction analysis (Cukα) of the manganese oxide.

9. The positive electrode active material according to claim 3, wherein the manganese oxide has a peak or peaks in the range of 2θ=38.0° to 39.5° and/or in the range of 2θ=77.0° to 79.0°, determined by X-ray powder diffraction analysis (Cukα) of the manganese oxide.

10. The positive electrode active material according to claim 4, wherein the manganese oxide has a peak or peaks in the range of 2θ=38.0° to 39.5° and/or in the range of 2θ=77.0° to 79.0°, determined by X-ray powder diffraction analysis (Cukα) of the manganese oxide.

11. The positive electrode active material according to claim 5, wherein the manganese oxide has a peak or peaks in the range of 2θ=38.0° to 39.5° and/or in the range of 2θ=77.0° to 79.0°, determined by X-ray powder diffraction analysis (Cukα) of the manganese oxide.

12. The positive electrode active material according to claim 6, wherein the manganese oxide has a peak or peaks in the range of 2θ=38.0° to 39.5° and/or in the range of 2θ=77.0° to 79.0°, determined by X-ray powder diffraction analysis (Cukα) of the manganese oxide.

13. A method of manufacturing a positive electrode active material, comprising preparing a positive electrode active material by heating a mixture of permanganate and a fused salt bed to a higher temperature than the melting temperature of the fused salt bed.

14. The method according to claim 13, wherein the permanganate is at least one substance selected from the group consisting of sodium permanganate, potassium permanganate, and rubidium permanganate.

15. The method according to claim 14, wherein the permanganate is sodium permanganate.

16. The method according to claim 13, wherein the fused salt bed is a mixture of lithium hydroxide and lithium nitrate.

17. A non-aqueous electrolyte secondary battery comprising a positive electrode, a negative electrode, and a non-aqueous electrolyte, the positive electrode comprising a positive electrode active material according to claim 1.

18. A non-aqueous electrolyte secondary battery comprising a positive electrode, a negative electrode, and a non-aqueous electrolyte, the positive electrode comprising a positive electrode active material according to claim 2.

19. A non-aqueous electrolyte secondary battery comprising a positive electrode, a negative electrode, and a non-aqueous electrolyte, the positive electrode comprising a positive electrode active material according to claim 3.

20. A non-aqueous electrolyte secondary battery comprising a positive electrode, a negative electrode, and a non-aqueous electrolyte, the positive electrode comprising a positive electrode active material according to claim 4.
